(19) United States
(12) Patent Application Publication
(10) Pub. No.: US 2005/0206172 A1
(43) Pub. Date: Sep. 22, 2005

(54) Rotary latch for vehicles and the like and method for making same

(76) Inventor: Bruce C. Bacon, Rockford, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/806,264

(22) Filed: Mar. 22, 2004

(51) Int. Cl. E05C 1/04

(52) U.S. Cl. 292/216

(57) ABSTRACT

A rotary latch and related method include a rigid U-shaped housing defined by a base and upstanding sidewalls having laterally aligned strike notches to selectively receive a lock strike therein. First and second sets of mounting apertures extend laterally through the sidewalls of the housing at locations spaced from the strike notches, and receive first and second retainers therein to rotatably mount a latch member and a release member within the housing. The pivot axes of the mounting apertures are disposed in a mutually parallel relationship, and are laterally aligned on the sidewalls to facilitate mounting the rotary latch in both left and right hand latch locations.

### BACKGROUND OF THE INVENTION

The present invention relates to latches, and in particular to a rotary latch for vehicles and the like, and method for making the same.

Releasable latches are used extensively in vehicles, such as boats, aircraft and the like, and in particular passenger cars, vans, trucks, motor coaches and recreational vehicles to secure hoods, trunk lids, access doors, storage compartment doors, tonneau covers and other similar closure structures. Many such releasable latches are known as slam latches, and interface with a lock strike to lock and unlock the associated closure. Slam latches typically include a latch member and a release member rotatably mounted in a housing and configured to selectively receive the lock strike therein. Relative motion between the housing and the lock strike rotate the latch member into a locked position in which the lock strike is retained in the housing. To release the lock strike, the release member is pivoted, thereby disengaging the latch member, and permitting the lock strike to be moved away from the housing.

Prior art slam latches, such as those disclosed in U.S. Pat. Nos. 4,896,906; 5,069,491 and 6,427,500 have a stamped and/or sheet formed metal housing which is not very rigid. Also such prior designs retain the latch and release members in the housing with their pivot axes arranged in a nonaligned condition. As a result, a separate bracket is required to mount the latch in left and right hand latch locations or installations. Because sheet formed housings are not particularly rigid, the latch components can become misaligned, particularly after extensive use.

Another problem typically experienced with prior art slam latches is that they require rather precise alignment with the lock strike to operate properly. When the latch member and lock strike become misaligned, such as when the closure and/or hinge is bent or out of square, the latch will not close properly, and can result in substantial impact between the lock strike and the latch housing, which damages the latch, and causes even further misalignment with the lock strike.

### SUMMARY OF THE INVENTION

One aspect of the present invention is a rotary latch of the type having a rotating latch member and a pivoting release member which selectively interact to retain and release a lock strike. The rotary latch includes a rigid, generally U-shaped housing defined by a base and opposing sidewalls upstanding from opposite sides of the base in a mutually parallel relationship, with a set of laterally aligned, outwardly opening strike notches in the sidewalls to selectively receive a portion of the lock strike therein. A first set of mounting apertures extends laterally through the sidewalls of the housing about a first pivot axis disposed generally perpendicular with the sidewalls and spaced laterally apart from the strike notches. A first retainer extends through the first set of mounting apertures, and pivotally mounts the latch member in the housing between the sidewalls for rotation in a plane generally parallel with the sidewalls. A second set of mounting apertures extends laterally through the sidewalls of the housing about a second pivot axis disposed generally parallel with and spaced laterally apart from the first pivot axis. A second retainer extends through the second set of mounting apertures and pivotally mounts the release member in the housing between the sidewalls for rotation in a generally parallel plane with the sidewalls, and selective engagement with the rotary latch. The first and second pivot axes are laterally aligned on the sidewalls to facilitate mounting the rotary latch in both left and right hand latch locations.

Another aspect of the present invention is a method for making rotary latches of the type having a rotary latch member and a pivoting release member which selectively interact to retain and release a lock strike. The method includes forming a rigid, generally U-shaped housing defined by a base and opposing sidewalls upstanding from opposite sides of the base in a mutually parallel relationship with a set of laterally aligned, outwardly opening strike notches in the sidewalls to selectively receive a portion of the lock strike therein. The method also includes forming a mounting apertures through the latch member and the release member, as well as forming a first set of mounting apertures laterally through the sidewalls of the housing about a first pivot axis disposed generally perpendicular with the sidewalls, and spaced laterally apart from the strike notches. The method further includes inserting a first retainer through the first set of housing mounting apertures and the mounting aperture in the latch member to pivotally mount the latch member in the housing between the sidewalls for rotation in a plane generally parallel with the sidewalls, forming a second set of mounting apertures laterally through the sidewalls of the housing about a second pivot axis disposed generally parallel with and spaced laterally apart from first pivot axis, and inserting a second retainer through the second set of housing mounting apertures and the mounting aperture in the release member to pivotally mount the release member in the housing between the sidewalls for rotation in a plane generally parallel with the sidewalls, and selective engagement with the rotary latch. Finally, the method also includes locating the first pivot axis and the second pivot axis in a laterally align relationship on the sidewalls to facilitate mounting the rotary latch in both left and right hand latch locations.

Yet another aspect of the present invention provides a rotary latch having an enlarged capture area or window between the housing and the lock strike to avoid contact between the same, even when the latch and the lock strike are somewhat misaligned. Preferably, the housing is die cast, to provide a very rigid structure that positively retains the lock strike, even after substantial use. The rotary latch has an uncomplicated design, is efficient in use, economical to manufacture, capable of a long operating life, and particularly well adapted for the purposed use.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a rotary latch and related mounting bracket embodying the present invention, with portions thereof broken away to reveal internal construction.

FIG. 2 is a side elevational view of the rotary latch, shown in a fully open position, with a lock strike approaching a latch member portion of the rotary latch.

FIG. 3 is a side elevational view of the rotary latch, shown in a first, partially closed locked position, with the lock strike captured therein.

FIG. 4 is a side elevational view of the rotary latch, shown in a second, fully closed locked position, with the lock strike captured therein.

FIG. 5 is a partially schematic, top plan view of a pair of rotary latches embodying the present invention, shown installed on opposite sides of an associated vehicle to retain an associated tonneau cover.

FIG. 6 is a top plan view of a housing portion of the rotary latch.

FIG. 7 is a left hand end elevational view of the housing.

FIG. 8 is a side elevational view of the housing.

FIG. 9 is a right hand end elevational view of the housing.

FIG. 10 is a top plan view of the latch member portion of the rotary latch.

FIG. 11 is a side elevational view of the latch member.

FIG. 12 is a top plan view of a release member portion of the rotary latch.

FIG. 13 is a side elevational view of the release member.

FIG. 14 is a side elevational view of the housing member, taken from the side opposite that shown in FIG. 8.

FIG. 15 is a vertical cross-sectional view of the rotary latch, showing a spring member installed therein.

FIG. 16 is an end view of a retainer portion of the rotary latch.

FIG. 17 is a side elevational view of the retainer.

FIG. 18 is a fragmentary side elevational view of the retainer installed in the housing.

### DETAILED DESCRIPTION OF THE PREFERRED EMBODIMENTS

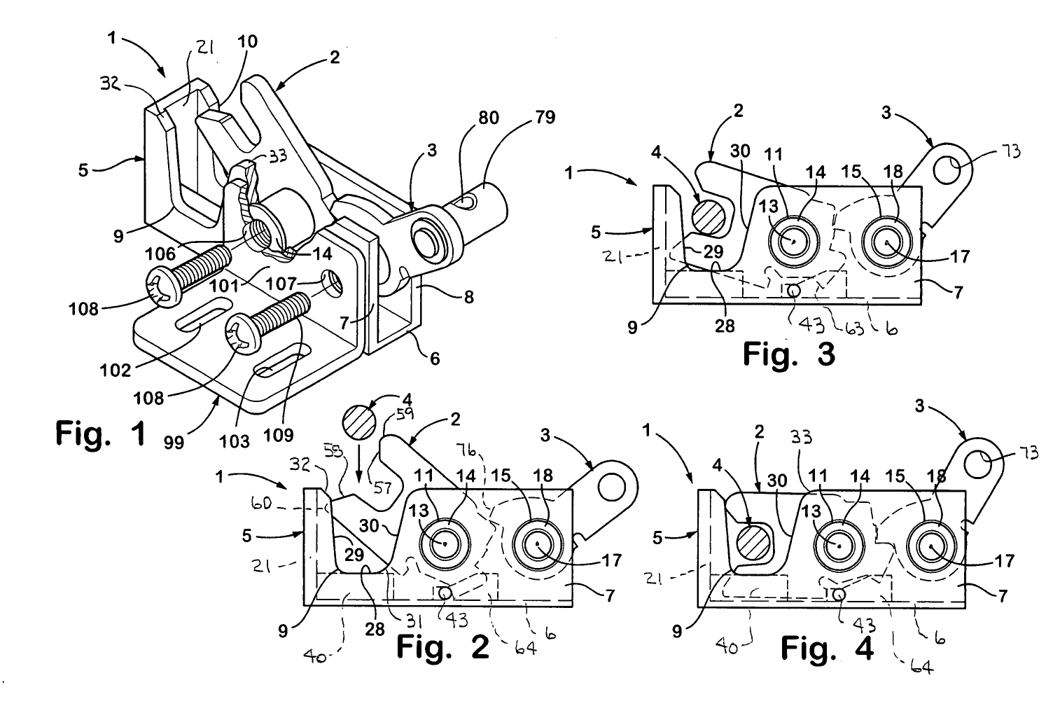

For purposes of description herein the terms “upper”, “lower”, “right”, “left”, “rear”, “front”, “vertical”, “horizontal” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the invented concepts defined in the appended claims. Hence, specific dimensions and other physical characteristics relating to the embodiments disclosed herein are not to be considered as limiting, unless the claims expressly state otherwise.

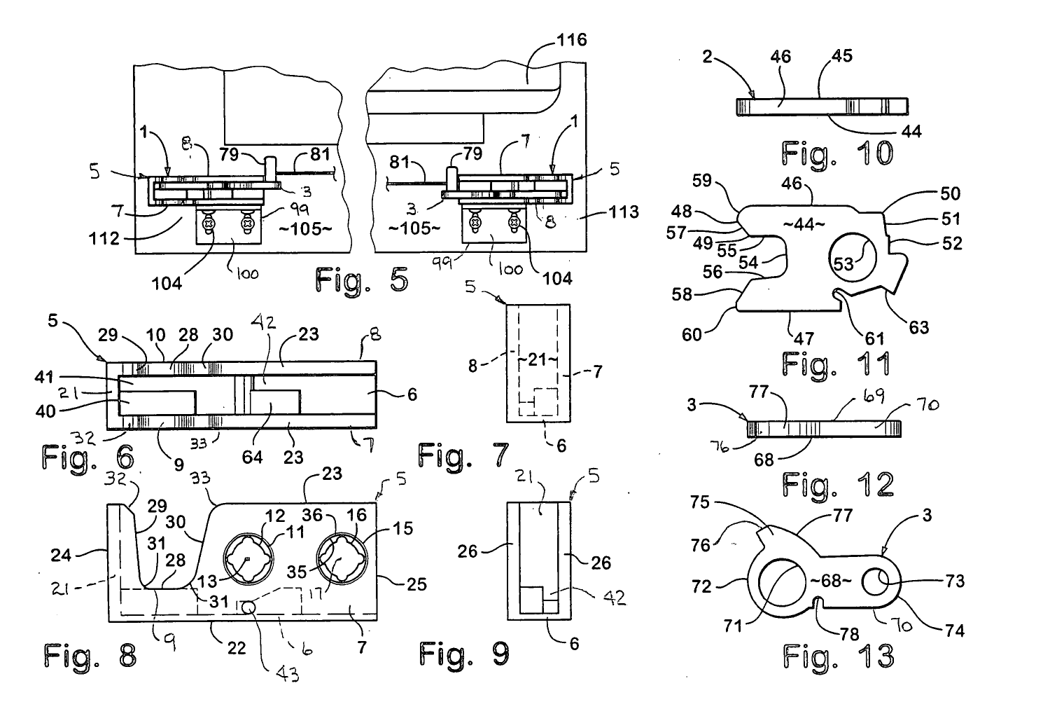

The reference numeral 1 (FIG. 1) generally designates a rotary latch embodying the present invention. Rotary latch 1 is of the type having a rotating latch member 2 and a pivoting release member 3, which selectively interact to retain and release an associated lock strike 4. Rotary latch 1 also includes a rigid, generally U-shaped housing 5 defined by a base 6 and opposing sidewalls 7 and 8 upstanding from opposite sides of base 6 in a mutually parallel relationship, with a set of laterally aligned outwardly opening strike notches 9 and 10 in sidewalls 7 and 8 to selectively receive a portion of lock strike 4 therein. A first set of mounting apertures, defined by apertures 11 and 12, extends laterally through the sidewalls 7 and 8 of housing 5 about a first pivot axis 13 disposed generally perpendicular with sidewalls 7 and 8 and spaced laterally apart from strike notches 9 and 10. A first retainer 14 extends through the first set of mounting apertures 11 and 12, and pivotally mounts latch member 2 in housing 5 between sidewalls 7 and 8 for rotation in a plane generally parallel with sidewalls 7 and 8. A second set of mounting apertures, defined by apertures 15 and 16, extends laterally through the sidewalls 7 and 8 of housing 5 about a second pivot axis 17, which is disposed generally parallel with and laterally spaced apart from the first pivot axis 13. A second retainer 18 extends through the second set of mounting apertures 15 and 16, and pivotally mounts release member 3 in the housing 5 between sidewalls 7 and 8 for rotation in a plane generally parallel with the sidewalls, and selective engagement with latch member 2. The first pivot axis 13 and the second pivot axis 17 are laterally aligned on the sidewalls 7 and 8 of housing 5 to facilitate mounting said rotary latch 1 in both left and right hand latch locations, as shown in FIG. 5.

In the illustrated example, housing 5 (FIGS. 6-9) has an integrally formed, one-piece construction, and is made from a rigid material, such as metal or the like. Preferably, housing 5 is die cast from aluminum, zinc, steel or other similar materials and/or alloys thereof. The illustrated housing 5 includes an integrally formed end wall 21 upstanding from base 6 at a location adjacent to strike notches 9 and 10, and serves to rigidify housing 5. End wall 21 extends completely across and integrally interconnects sidewalls 7 and 8 at one end thereof, and has a height substantially commensurate with the height of sidewalls 7 and 8. The opposite end of housing 5 is open and U-shaped, and is adapted to receive release member 3 therethrough. The cast construction of housing 5 provides a very rigid structure for precisely retaining latch member 2 and release member 3 therein for rotation about pivot axes 13 and 17.

With reference to FIG. 8, the illustrated housing 5 has a generally rectangular side elevational configuration, having a flat bottom surface 22 defined by the exterior surface of base 6, top edges 23 defined by the top edges of sidewalls 7 and 8 and end wall 21, a flat, closed end surface 24 defined by the exterior surface of end wall 21, and an open end 25 defined by the end edges 26 of sidewalls 7 and 8.

The illustrated strike notches 9 and 10 are substantially identical in shape and size, and in the illustrated example, have a generally U-shaped configuration defined by a bottom edge 28 and first and second side edges 29 and 30 respectively, which extend outwardly from bottom edge 28. The first side edge 29 is disposed at a first acute angle relative to bottom edge 28, and the second side edge 30 is disposed at a second acute angle relative to bottom edge 28. The second side edge 30, which is disposed closest to first pivot axis 13, is oriented at an angle that is less than the angle of side edge 29. In the illustrated example, side edge 29 is disposed at an angle of approximately 85 degrees with respect to base 6, while side edge 30 is disposed at an angle of approximately 75 degrees relative to base 6. Bottom edge 28 is disposed generally parallel with base 6, and includes arcuately-shaped corners 31 which blend into side edges 29 and 30. To facilitate insertion of lock strike 4 into housing 5, the junction between side edge 29 and top edge 23 preferably has an angled or chamfered portion 32, and the junction between side edge 30 and top edge 23 has a rounded or radiused portion 33.

As best illustrated in FIGS. 6-9, the illustrated housing base 6 has a stepped interior surface, with an upstanding block 40 disposed adjacent to sidewall 8 under strike notch 9, which forms a narrow well 41 into which the outward portion of the lower edge of latch member 3 is closely received when in the fully closed locked position shown in FIG. 4 to provide additional security and rigidity. Also, a ramp-shaped stop block 64 is upstanding from base 6 at a location generally below the first set of apertures 11, 12, which interacts with latch member 2 in the manner described below. Stop block 64 also forms a narrow well 42 into which the inward portion of the lower edge of latch member 3 is closely received when in the fully closed position shown in FIG. 4 to provide additional security and rigidity. A steel pin 43 extends laterally through mating apertures in sidewalls 7 and 8 and stop block 64, and provides a hard, durable surface against which latch member 2 abuts in the open position shown in FIG. 2.

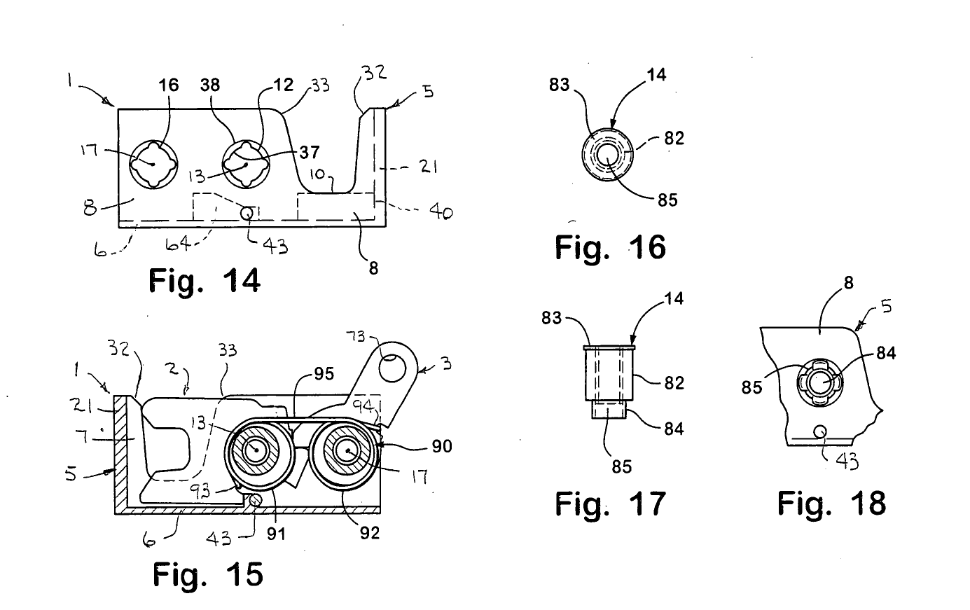

In the illustrated example, the first set of mounting apertures 11, 12 are substantially identical in shape and size to that of the second set of mounting apertures 15, 16, such that a common retainer can be used for both. With reference to FIG. 8, mounting apertures 11 and 15 are disposed in sidewall 7, and have a generally circular plan shape, defined by an interior surface 35 and an exterior surface 36, which are configured to closely receive and retain the head portion of an associated one of the retainers 14, 18 therein in the manner described in greater detail hereinafter. With reference to FIG. 14, mounting apertures 12 and 16 are disposed in sidewall 8, opposite mounting apertures 11 and 15, and have a non-circular interior surface 37 and a circular exterior surface 38 configured to receive and retain the shaft end of an associated one of the retainers 14, 18 therein in the manner described in greater detail hereinafter. Mounting apertures 11 and 12 are concentric about first pivot axis 13, while mounting apertures 15 and 16 are concentric about second pivot axis 17. Pivot axes 13 and 17 are mutually parallel, and lie along a plane that is substantially parallel with base 6, such that the same are laterally aligned on sidewalls 7 and 8 to facilitate mounting rotary latch 1 in both left and right hand locations or applications, as described in greater detail below.

With reference to FIGS. 10 and 11, the illustrated latch member 2 has a generally plate-shaped configuration, comprising opposite side faces 44 and 45, opposite side edges 46 and 47, an exterior end edge 48 with a U-shaped notch 49 therein, and an interior end edge 50 with pawl surfaces or notches 51 and 52. The interior end portion of latch member 2 has a circular aperture 53 therethrough configured to closely receive therein retainer 14 to pivotally mount latch member 2 in housing 5. The U-shaped notch 49 at the exterior end of latch member 2 is tapered, and defined by base edge 54, oppositely tapered side edges 55 and 56, and angled end edges 57 and 58, which transition into side edges 46 and 47 at arcuately formed corners 59 and 60. Preferably, the junction between base edge 54 and side edges 55 and 56 is also rounded or radiused to facilitate engagement with lock strike 4. Latch member 2 also includes a spring retention notch 61 disposed adjacent side edge 47 to receive and retain one end of a spring 62 therein, as described below in greater detail. The interior end of latch member 2 also includes a stop surface 63 which is received in well 42, and selectively engages stop pin 43, which extends along the base 6 of housing 5 to positively locate latch member 2 in a fully open position, as illustrated in FIG. 2.

With reference to FIGS. 12 and 13, the illustrated release member 3 has a plate-like construction, comprising opposite side faces 68 and 69 and a marginal edge 70. In the illustrated example, release member 3 has a generally ovate side elevational configuration with a circular retainer aperture 71 disposed adjacent an inward end 72 of release member 3, and a circular release knob aperture 73 disposed adjacent an outward end 74 of release member 3. Both the inward and outward ends 72 and 74 of release member 3 are arcuate in shape. A pawl arm 75 extends radially outwardly from the marginal edge 70 of release member 3 at a location adjacent retainer aperture 71, and includes a substantially straight engagement surface 76 which engages pawl notches 51 and 52 on latch member 2 in the manner described in greater detail below. Pawl arm 75 also includes an arcuately inclined top surface or edge 77. Release member 3 further includes a spring retention notch 78 disposed in marginal edge 70 opposite pawl arm 75 to receive and retain one end of spring 62 therein, as described below in greater detail. In the example shown in FIG. 1, a cable barrel 79 is mounted in release knob aperture 73, and extends laterally outwardly from one of the side faces 68 and 69 of release member 3. Cable barrel 79 includes a radially extending aperture 80 to attach an associated actuator cable 81 to release member 3 to release latch member 2 from its locked positions.

With reference to FIGS. 16-18, the illustrated retainers 14 and 18 have a substantially identical size and shape, wherein each includes a hollow cylindrical body 82, with an enlarged head 83 at one end thereof, and a shank 84 disposed at the opposite end thereof. The head 83 of each of the retainers 14, 18 has a generally circular elevational configuration that is sized to be closely received within the mounting apertures 11 and 15 in sidewall 7 of housing 5. The shank 84 of each of the retainers 14, 18 is generally cylindrical in shape, and sized to be closely received within the mounting apertures 12, 16 in the opposite sidewall 8 of housing 5. The shank 84 of each of the retainers 14, 18 is also sized to be closely received through the aperture 53 of latch member 2 and the aperture 71 of release member 3 to pivotally mount the same within housing 5. The hollow cylindrical body 82 of each of the retainers 14, 18 includes an internally threaded aperture 85 extending coaxially therethrough to facilitate mounting housing 5 at a predetermined location using L-bracket 99 as described below.

With reference to FIG. 15, the illustrated rotary latch 1 also includes a biasing member 90 which resiliently urges latch member 2 toward the fully open position illustrated in FIG. 1. The illustrated biasing member is in the form of a spring having opposite circular coils 91 and 92 configured for mounting about retainers 14, 18 respectively. The free end 93 of coil 91 is received in the notch 61 of latch member 2, and the free end 94 of coil 92 is received in the notch 78 of release member 3. Spring 90 has a one-piece construction, wherein a generally straight medial portion 95 spans between and connects the opposite coils 91 and 92. In the orientation illustrated in FIG. 2, coil 91 is wound to resiliently bias latch member 2 in a clockwise direction, while coil 92 is wound to resiliently bias release member 3 in a counterclockwise direction. Hence, the interior end 50 of latch member 2 and the interior end 72 of release member 3 are resiliently biased together in opposite rotary directions, such that pawl arm 75 selectively engages the pawl notches 51 and 52 in the manner described in greater detail below.

With reference to FIG. 1, the illustrated L-bracket 99 has a generally L-shaped side elevational configuration, defined by perpendicularly oriented flanges 100 and 101. Flange 100 typically forms the base of L-bracket 99, and includes a pair of elongated apertures 102 and 103 through which fasteners 104 are inserted to attach L-bracket 99 to an associated support surface, such as the vehicle bed 105 illustrated in FIG. 5. Flange 101 includes a pair of horizontally oriented fastener apertures 106 and 107 which are disposed in a generally coaxial relationship with the first and second pivot axes 13 and 17 when L-bracket 99 and rotary latch 1 are positioned in the side-by-side fashion illustrated in FIGS. 1 and 5. The illustrated fastener apertures 106 and 107 have a generally circular plan shape, and are adapted to receive therethrough threaded fasteners 108, which are received closely through fastener apertures 106 and 107, and include threaded shanks 109 which engage the threaded apertures 85 in retainers 14 and 18.

It is to be understood that L-bracket 99 may assume alternate configurations to accommodate mounting rotary latch 1 in a specific application. For example, elongate apertures 102 and 103 may be oriented along the length of flange 100. Also, bracket 99 may be equipped with an L-shaped support pad along the upper edge of flange 101 to support a pivoting connector arm or bell crank to adapt rotary latch 1 for both a straight pull version, wherein cable 81 is oriented parallel with rotary latch 1 (FIG. 5), and a side pull version, wherein cable 81 is oriented perpendicular with rotary latch 1.

As best illustrated in FIGS. 1-5, because the first and second pivot axes 13 and 17 are laterally aligned on the sidewalls 7 and 8 of housing 5, L-bracket 99 can be used to mount rotary latch 1 at either the left hand position 112 shown in FIG. 5, or the right hand position 113 shown in FIG. 5. More specifically, when mounting rotary latch 1 at the left hand position 112, rotary latch 1 is positioned on vehicle bed 105 such that the sidewall 7 of housing 5 is facing the rear of the vehicle bed, and sidewall 8 faces the front of the vehicle bed, with cable barrel 79 pointing inwardly. Strike notches 9 and 10 on rotary latch 1 are aligned with the associated lock strike 4 on the vehicle cover 116. The base flange 100 of L-bracket 99 is then attached to the vehicle bed 105 by fasteners 104. Fasteners 108 are then inserted through the fastener apertures 106 and 107 on flange 101 to securely retain rotary latch 1 in place.

In a similar fashion, rotary latch 1 is mounted in the right hand latch location 113 in the following manner. Rotary latch 1 is oriented such that sidewall 8 faces the rear of the vehicle bed, and sidewall 7 faces the front of the vehicle bed, with cable barrel 79 pointing forwardly, as shown in FIG. 5. The strike notches 9 and 10 are aligned with the lock strike 4 on the right hand side of the vehicle cover 116. L-bracket 99 is then positioned along side of rotary latch 1, such that fastener apertures 106 and 107 are concentric with the pivot axes 13 and 17 respectively. Fasteners 104 are then inserted through the apertures in base flange 100 to securely mount L-bracket 99 to vehicle bed 105. Fasteners 108 are then inserted through fastener apertures 106 and 107 in flange 101, and engaged in the threaded apertures 85 of retainers 14 and 18. Cables 81 are attached to both cable barrels 79, and routed to a conventional actuator, such as a T-handle, Bowden cable hood/trunk release or the like.

With reference to FIGS. 2-4, when latch member 2 is in the fully open position shown in FIG. 2, U-shaped notch 49 is oriented upwardly at an angle of around 45 degrees, such that upper angled end edge 57 extends generally vertically, and lower angled end edge 58 extend generally horizontally, with rounded tip 60 extending past side edges 29 of strike notches 9 and 10, into a position between sidewalls 7 and 8. The lateral opening between side edges 29 of strike notches 9 and 10, and end edge 57 of latch member 3, as shown in FIG. 2, particularly in combination with chamfered housing edge 32, and the angled end edge 57 of latch member 2, provides an enlarged capture area or window into which lock strike 4 can be received, and properly engage latch member 3 to shift the same to one of the two closed positions shown in FIGS. 3 and 4. Hence, even if lock strike 4 and rotary latch 1 are slightly misaligned, strike lock 4 will not abut or impact housing 5, but will rather engage only latch member 2, to avoid damage or further misalignment for rotary latch 1.

When strike lock 4 rotates latch member 2 to the position shown in FIG. 3, the engagement surface 76 on the pawl arm 75 of release member 3 contacts the first pawl notch 51 on latch member 2, so as to positively retain lock strike 4 in rotary latch 1 in a partially closed, yet locked condition. This position is typically a safety feature which assures that the associated closure will not inadvertently open, even if rotary latch 1 is not in the fully closed, locked position shown in FIG. 4. Further engagement between lock strike 4 and latch member 3 will rotate the latter to the fully closed, locked position shown in FIG. 4, wherein the engagement surface 76 on the pawl arm 75 of release member 3 contacts the second pawl notch 52 on latch member 2 to positively retain the same in place.

While the rotary latch 1 shown in FIGS. 1-18 is a two position latch, as described above, it is to be understood that the present invention is equally applicable to single position latches of the type having just one notch on latch member 2.

To release lock strike 4, and open the associated closure, cables 81 are tensed, which rotates both release members 3, disengaging the same from latch members 2, such that springs 90 rotate the latch members 2 back to the open, unlocked position shown in FIG. 2.

Rotary latch 1 has a unique die cast construction that is very rigid, and configured to facilitate mounting in either right or left hand installations or applications. Rotary latch 1 has a very wide alignment window with the associated lock strike 4, such that lock strike 4 does not inadvertently contact housing 5, even when rotary latch 1 and lock strike 4 are somewhat misaligned.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. In a rotary latch of the type having a rotating latch member and a pivoting release member which selectively interact to retain and release a lock strike, the improvement comprising:
a rigid, generally U-shaped housing defined by a base and opposing sidewalls upstanding from opposite sides of said base in a mutually parallel relationship, with a set of laterally aligned outwardly opening strike notches in said sidewalls to selectively receive a portion of the lock strike therein;
a first set of mounting apertures extending laterally through said sidewalls of said housing about a first pivot axis disposed generally perpendicular with said sidewalls and spaced laterally apart from said strike notches;
a first retainer extending through said first set of mounting apertures, and pivotally mounting said latch member in said housing between said sidewalls for rotation in a plane generally parallel with said sidewalls;
a second set of mounting apertures extending laterally through said sidewalls of said housing about a second pivot axis disposed generally parallel with and spaced laterally apart from said first pivot axis; and
a second retainer extending through said second set of mounting apertures, and pivotally mounting said release member in said housing between said sidewalls for rotation in a plane generally parallel with said sidewalls, and selective engagement with said latch member; said first pivot axis and the second pivot axis being laterally aligned on said sidewalls to facilitate mounting said rotary latch in both left and right hand latch locations.

2. A rotary latch as set forth in claim 1, including:
a mounting bracket adapted to mount said housing on an associated support surface, and including first and second fasteners connected with said first and second retainers in a generally coaxial relationship to mount said housing in both the left and right hand latch locations.

3. A rotary latch as set forth in claim 2, wherein:
said housing includes an upstanding end wall formed integrally with said base and said sidewalls at a location adjacent to said strike notches to rigidify said housing.

4. A rotary latch as set forth in claim 3, wherein:
said housing includes an open, U-shaped end disposed opposite said end wall.

5. A rotary latch as set forth in claim 4, wherein:
said first and second pivot axes lie in a plane disposed generally parallel with said base.

6. A rotary latch as set forth in claim 5, wherein:
said housing has a die cast construction.

7. A rotary latch as set forth in claim 6, wherein:
said latch member is configured and positioned to extend completely across said strike notches for improved engagement with the lock strike.

8. A rotary latch as set forth in claim 7, wherein:
said first set of mounting apertures has a size and shape substantially identical with the size and shape of said second set of mounting apertures.

9. A rotary latch as set forth in claim 8, wherein:
said first and second retainers have a substantially identical size and shape.

10. A rotary latch as set forth in claim 9, wherein:
said first and second sets of mounting apertures each include a circular aperture disposed in a first one of said sidewalls, and a non-circular aperture disposed in a second one of said sidewalls.

11. A rotary latch as set forth in claim 10, wherein:
said first and second retainers each have a hollow cylindrical body, with an enlarged head end thereof received in said circular aperture of said first one of said sidewalls, and a shank end thereof received in said non-circular aperture of said second one of said sidewalls, and deformed therein to secure said retainers in said housing.

12. A rotary latch as set forth in claim 11, wherein:
said hollow cylindrical body of said retainers is internally threaded to receive said first and second fasteners therein, and attach said housing to said mounting bracket.

13. A rotary latch as set forth in claim 12, wherein:
said housing includes a stop positioned along said base to abut said latch member and positively locate the same in a predetermined open position.

14. A rotary latch as set forth in claim 13, wherein:
said non-circular aperture includes at least one radially extending notch.

15. A rotary latch as set forth in claim 14, including:
a coil spring mounted in said housing and resiliently biasing said latch member toward said open position.

16. A rotary latch as set forth in claim 15, wherein:
said latch member includes at least two notches which are selectively engaged by said release member to retain said latch member in first and second closed positions.

17. A rotary latch as set forth in claim 16, wherein:
said strike notches have a generally U-shaped configuration defined by a bottom edge, and first and second side edges extending outwardly from said bottom edge.

18. A rotary latch as set forth in claim 17, wherein:
said first side edge is disposed at a first acute angle relative to said bottom edge.

19. A rotary latch as set forth in claim 18, wherein:
said second side edge is disposed at a second acute angle relative to said bottom edge.

20. A rotary latch as set forth in claim 19, wherein:
said second edge is disposed closest to said first pivot axis; and
said second acute angle is less than said first acute angle.

21. A rotary latch as set forth in claim 20, wherein:
said bottom edge is disposed substantially parallel with said base.

22. A rotary latch as set forth in claim 21, wherein:
said latch member includes a generally U-shaped outwardly opening notch configured to receive and selectively retain therein a portion of the lock strike.

23. A rotary latch as set forth in claim 22, wherein:
said latch member notch is at least in part defined by opposed tapered outer ends to facilitate guiding the lock strike into said latch member notch.

24. A rotary latch as set forth in claim 23, wherein:
said latch member includes a laterally extending aperture through which said first retainer is closely received to pivotally mount said latch member in said housing.

25. A rotary latch as set forth in claim 24, wherein:
said release member includes a laterally extending aperture through which said second retainer is closely received to pivotally mount said release member in said housing.

26. A rotary latch as set forth in claim 1, wherein:
said housing includes an upstanding end wall formed integral with said base and said sidewalls at a location adjacent to said strike notches to rigidify said housing.

27. A rotary latch as set forth in claim 1, wherein:
said housing includes an open, U-shaped end disposed adjacent said second pivot axis.

28. A rotary latch as set forth in claim 1, wherein:
said first and second pivot axes lie in a plane disposed generally parallel with said base.

29. A rotary latch as set forth in claim 1, wherein:
said housing has a die cast construction.

30. A rotary latch as set forth in claim 1, wherein:
said latch member is configured and positioned to extend completely across said strike notches for improved engagement with the lock strike.

31. A rotary latch as set forth in claim 1, wherein:
said first set of mounting apertures has a size and shape substantially identical with the size and shape of said second set of mounting apertures.

32. A rotary latch as set forth in claim 1, wherein:
said first and second retainers have a substantially identical size and shape.

33. A rotary latch as set forth in claim 1, wherein:
said first and second sets of mounting apertures each include a circular aperture disposed in a first one of said sidewalls, and a non-circular aperture disposed in a second one of said sidewalls.

34. A rotary latch as set forth in claim 1, wherein:
said housing includes a stop positioned along said base to abut said latch member and positively locate the same in a predetermined open position.

35. A rotary latch as set forth in claim 1, including:
a coil spring mounted in said housing and resiliently biasing said latch member toward an open position.

36. A rotary latch as set forth in claim 1, wherein:
said latch member includes at least two notches which are selectively engaged by said release member to retain said latch member in first and second closed positions.

37. A rotary latch as set forth in claim 1, wherein:
said strike notches have a generally U-shaped configuration defined by a bottom edge, and first and second side edges extending outwardly from said bottom edge.

38. A rotary latch as set forth in claim 37, wherein:
said first side edge is disposed at a first acute angle relative to said bottom edge;
said second side edge is disposed at a second acute angle relative to said bottom edge;
said second edge is disposed closest to said first pivot axis; and
said second acute angle is less than said first acute angle.

39. A rotary latch as set forth in claim 38, wherein:
said bottom edge is disposed substantially parallel with said base.

40. A rotary latch as set forth in claim 1, wherein:
said latch member includes a generally U-shaped outwardly opening notch configured to receive and selectively retain therein a portion of the lock strike.

41. A rotary latch as set forth in claim 40, wherein:
said latch member notch is at least in part defined by opposed tapered outer ends to facilitate guiding the lock strike into said latch member notch.

42. In a method for making rotary latches of the type having a rotating latch member and a pivoting release member which selectively interact to retain and release a lock strike, the improvement comprising:
forming a rigid, generally U-shaped housing defined by a base and opposing sidewalls upstanding from opposite sides of the base in a mutually parallel relationship, with a set of laterally aligned, outwardly opening strike notches in the sidewalls to selectively receive a portion of the lock strike therein;
forming mounting apertures through both the latch member and the release member;
forming a first set of mounting apertures laterally through the sidewalls of the housing about a first pivot axis disposed generally perpendicular with the sidewalls, and spaced laterally apart from the strike notches;
inserting a first retainer through the first set of housing mounting apertures and the mounting aperture in the latch member to pivotally mount the latch member in the housing between the sidewalls for rotation in a plane generally parallel with the sidewalls;
forming a second set of mounting apertures laterally through the sidewalls of the housing about a second pivot axis disposed generally parallel with and spaced laterally apart from the first pivot axis;
inserting a second retainer through the second set of housing mounting apertures and the mounting aperture in the release member to pivotally mount the release member in the housing between the sidewalls for rotation in a plane generally parallel with the sidewalls, and selective engagement with the latch member; and
locating the first pivot axis and the second pivot axis in a laterally aligned relationship on the sidewalls to facilitate mounting the housing at both left and right hand latch locations.

43. A method as set forth in claim 42, wherein:
said housing forming step comprises die casting the housing to achieve improved rigidity.

44. A method as set forth in claim 43, including:
forming a mounting bracket adapted to mount the housing on an associated support surface, including forming first and second fastener apertures therethrough arranged so as to assume a generally coaxial relationship with the first and second retainers when positioned side-by-side; and
inserting first and second fasteners through the first and second fastener apertures in the mounting bracket, and attaching the first and second fasteners to the first and second retainers to mount the rotary latch in either right or left hand latch locations.

45. A method as set forth in claim 44, wherein:
said first and second sidewall mounting aperture forming steps include forming the first and second sets of mounting apertures with a substantially identical size and shape to receive a common retainer therein.

46. A method as set forth in claim 45, wherein:
said first sidewall mounting aperture forming step includes positioning the first set of mounting apertures in the sidewalls of the housing at a location which ensures that the latch member extends completely across the strike notches for improved engagement with the lock strike.

47. A method as set forth in claim 46, wherein:
said first and second mounting aperture forming steps include forming a circular aperture in a first one of the sidewalls, and forming a non-circular aperture disposed in a second one of the sidewalls.

48. A method as set forth in claim 47, wherein:
said housing forming step includes forming a stop in the housing at a position to abut the latch member and positively locate the same in a predetermined open position.

49. A method as set forth in claim 48, including:
assembling a coil spring in the housing to resiliently bias the latch member toward the open position.

50. A method as set forth in claim 49, including:
forming at least two notches on the latch member which are selectively engaged by the release member to retain the latch member in first and second closed positions.

51. A method as set forth in claim 50, wherein:
said housing forming step includes forming the strike notches in a generally U-shaped configuration defined by a bottom edge, and first and second side edges extending outwardly from said bottom edge;
orienting the first side edge at a first acute angle relative to said bottom edge;
orienting the second side edge at a second acute angle relative to said bottom edge; and
positioning the second edge closest to the first pivot axis, and forming the second acute angle less than the first acute angle.

52. A method as set forth in claim 51, including:
forming a generally U-shaped outwardly opening notch in the latch member to receive and selectively retain therein a portion of the lock strike, and having a tapered outer end to facilitate guiding the lock strike into said latch member notch.

53. A method as set forth in claim 52, wherein:
said housing forming step includes integrally forming an end wall upstanding from the base at a location adjacent to the strike notches to rigidify the housing.
